(19) United States
(12) Patent Application Publication
(10) Pub. No.: US 2022/0003850 A1
(43) Pub. Date: Jan. 6, 2022

(54) RANGING DEVICE, RANGING METHOD, AND MOBILE PLATFORM

(71) Applicant: SZ DJI TECHNOLOGY CO., LTD., Shenzhen (CN)

(72) Inventors: Xiang LIU, Shenzhen (CN); Shuai DONG, Shenzhen (CN); Xiaoping HONG, Shenzhen (CN)

(21) Appl. No.: 17/406,972

(22) Filed: Aug. 19, 2021

Related U.S. Application Data
(63) Continuation of application No. PCT/CN2019/075588, filed on Feb. 20, 2019.

(51) Int. Cl. G01S 7/4865; G01S 17/10; G01S 7/497; G01S 7/481

(52) U.S. Cl. CPC G01S 7/4865; G01S 7/4814; G01S 7/497; G01S 17/10

(57) ABSTRACT

A ranging device includes a threshold determination circuit and a detection channel. The threshold determination circuit is configured to determine a candidate comparison threshold according to a threshold-influencing factor. The detection channel is configured to receive a light pulse signal reflected by an object, convert the light pulse signal into an electrical signal, compare the electrical signal with the candidate comparison threshold, obtain time information of the electrical signal triggering the candidate comparison threshold, and determine a distance between the object and the ranging device according to the time information.

### CROSS-REFERENCE TO RELATED APPLICATION

This application is a continuation of International Application No. PCT/CN2019/075588, filed Feb. 20, 2019, the entire content of which is incorporated herein by reference.

### TECHNICAL FIELD

The present disclosure relates to the technical field of LIDAR and, more particularly, to a ranging device, a ranging method, and a mobile platform.

### BACKGROUND

A LIDAR is a sensing system of outside world, which can learn three-dimensional information of the outside world, and is no longer limited to a plane sensing of the outside world such as a camera. The principle is to actively transmit a laser pulse signal to outside, detect reflected pulse signal, and determine distance of a measured object according to time difference between transmission and reception. Three-dimensional depth information can be reconstructed by combining with transmission angle information of light pulses.

In the LIDAR, measuring farther distance is an important indicator, and the LIDAR receives pulse signals and noises during the measurement. In order to measure farther, it needs to have sufficient signal-to-noise ratio, and the higher the signal-to-noise ratio, the farther the distance can be measured.

Therefore, how to reduce the noise in a ranging device of the LIDAR to avoid interference to an effective signal and increase measurement distance has become a problem that needs to be solved.

### SUMMARY

In accordance with the disclosure, there is provided a ranging device including a threshold determination circuit and a detection channel. The threshold determination circuit is configured to determine a candidate comparison threshold according to a threshold-influencing factor. The detection channel is configured to receive a light pulse signal reflected by an object, convert the light pulse signal into an electrical signal, compare the electrical signal with the candidate comparison threshold, obtain time information of the electrical signal triggering the candidate comparison threshold, and determine a distance between the object and the ranging device according to the time information.

Also in accordance with the disclosure, there is provided a ranging method. The ranging method includes determining a candidate comparison threshold according to a threshold-influencing factor, receiving a light pulse signal reflected by an object, converting the light pulse signal into an electrical signal, comparing the electrical signal with the candidate comparison threshold, obtaining time information of the electrical signal triggering the candidate comparison threshold, and determining a distance between the object and the ranging device according to the time information.

### BRIEF DESCRIPTION OF THE DRAWINGS

In order to explain the embodiments of the present disclosure more clearly, reference is made to the accompanying drawings, which are used in the description of the embodiments. Obviously, the drawings in the following description are some embodiments of the present disclosure, and other drawings can be obtained from these drawings without any inventive effort for those of ordinary skill in the art.

FIG. 1 is a schematic diagram showing a pulse signal and a noise signal obtained by a ranging device according to an embodiment of the present disclosure.

FIG. 2 is a schematic diagram showing difference in effective receiving area caused by difference in receiving field of view and correction according to an embodiment of the present disclosure.

FIG. 3 is a schematic structural diagram of multiple detection channels according to an embodiment of the present disclosure.

FIG. 4 is a schematic block diagram of a ranging device according to an embodiment of the present disclosure.

FIG. 5 is a schematic diagram showing an embodiment in which a ranging device employs a coaxial optical path.

### DETAILED DESCRIPTION OF THE EMBODIMENTS

The technical solutions in the embodiments of the present disclosure will be described in detail with reference to the accompanying drawings. Obviously, the described embodiments are only some of rather than all the embodiments of the present disclosure. Based on the described embodiments, all other embodiments obtained by those of ordinary skill in the art without inventive effort shall fall within the scope of the present disclosure.

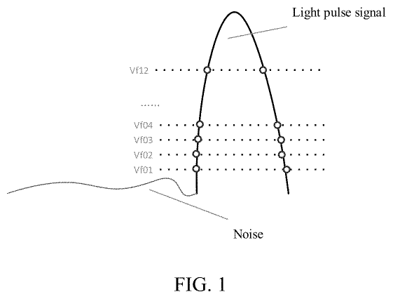

For a LIDAR, measuring farther distance is an important indicator. In order to measure farther, it is needed to reduce influence of noise. Signals received by various measurement devices include pulse signals and noises during the measurement, and the pulse signals are always accompanied by noises. In order to reduce the influence of noise, threshold can be determined by setting signal amplitude in a multi-threshold sampling circuit scheme, so that only echo signal can trigger the threshold, while the noise cannot trigger the threshold, as shown in FIG. 1. When the noise triggers the threshold, a false detection signal, i.e., so-called false alarm noise, will be formed. The signal amplitude will attenuate as the distance increases, and the threshold cannot be triggered when the signal amplitude is below the set threshold, which determines system range.

There are noises in a LIDAR ranging system, including noise of circuit itself and noise formed by detection of stray light in environment by a detector. Detection threshold of the system needs to be set according to noise level, so that frequency of the false alarm noise is less than a specific value, which facilitates subsequent applications. Value of the threshold is directly related to the system range, and the smaller the threshold, the smaller the range under the same other conditions.

There are many sources of noise, mainly including light noise that comes from sunlight and other artificial light in the environment, such as strong light noise in a summer noon, and electronic noise that comes from inherent noise of circuit, optoelectronic device, etc.

In order to overcome the above problems, the present disclosure provides a ranging device, so as to obtain the best signal-to-noise ratio in different scenarios, collect the weakest signal, and measure the farthest distance. The ranging device includes a detection channel and a threshold determination circuit. The threshold determination circuit is configured to determine a comparison threshold to be used (also referred to as a “candidate comparison threshold”) according to threshold-influencing factors. The detection channel is configured to receive a light pulse signal reflected by an object, convert the light pulse signal into an electrical signal, compare the electrical signal with the comparison threshold to be used, obtain time information of the electrical signal triggering the comparison threshold to be used, and determine a distance between the object and the ranging device according to the time information.

For example, the threshold determination circuit is configured to perform at least one of a dynamic threshold adjustment or a dynamic threshold selection.

For dynamic threshold adjustment, the threshold determination circuit is configured to adjust the set comparison threshold according to the threshold-influencing factors, and the comparison threshold to be used includes the adjusted comparison threshold.

Specifically, as shown in FIG. 1, in order to avoid the noise triggering the set comparison threshold, multiple different set comparison thresholds are usually set in the ranging device.

In some embodiments of the present disclosure, setting of the comparison threshold may be dynamically configured by a digital-to-analog conversion method (for example, using an analog-to-digital converter, digital-to-analog converter, DAC), a digital potentiometer, etc.

In the ranging device, the DAC is generally controlled by FPGA, MCU, or another central control unit. The central control unit dynamically sets the threshold according to stored individual difference and channel difference. The central control unit can also dynamically adjust the threshold according to some measured parameters such as external light intensity.

For example, in some embodiments of the present disclosure, the detection channel at least includes a comparator. A first input terminal of the comparator is configured to receive the electrical signal converted from the light pulse signal, a second input terminal of the comparator is configured to receive the set comparison threshold, and an output terminal of the comparator is configured to output comparison result including the time information corresponding to the electrical signal.

The ranging device also includes a controller and a digital-to-analog converter, which are connected to one terminal of the threshold determination circuit, and are configured to adjust the threshold set by the detection channel to the adjusted comparison threshold. The controller is connected to the second input terminal of the comparator through the digital-to-analog converter, and adjusts the comparison threshold set by the comparator by controlling value of output voltage of the digital-to-analog converter.

In some embodiments of the present disclosure, for example, in an environment with strong light noise, the central control unit learns this information and controls the DAC or another circuit part that can adjust the threshold to increase the threshold, so as to avoid high light noise. While in an environment with low light noise, such as an application scenario in dark night with no light, the threshold can be lowered to obtain a farther measurement distance.

In the ranging device, fully taking into account different environments and different individual differences, the threshold determination circuit dynamically adjusts the comparison threshold to be used according to different environments, so as to ensure that in scenarios such as no light or considering individual difference, a higher signal-to-noise ratio and a better measurement effect can be obtained.

For dynamic threshold selection, the detection channel is configured to compare the electrical signal with the set comparison threshold, and the threshold determination circuit is configured to select the set comparison threshold to be used from the set comparison thresholds according to the threshold-influencing factors. The detection channel is also configured to determine the distance between the object and the ranging device according to the time information corresponding to the comparison threshold to be used.

For example, the detection channel also includes a time-to-digital converter. The time-to-digital converter is electrically coupled to the output terminal of the comparator, and is configured to extract the time information corresponding to the electrical signal according to the comparison result output by the comparator.

In actual applications, there are application scenarios that require fast switching. For example, in a multi-channel sensor scheme, if an acquisition circuit uses multiplexing mode, that is, the same threshold sampling circuit needs to time-division acquisition of different detection channels, and speed of switching between different channels is relatively fast, generally in us level. The individual differences between different channels (which will be described below) require that the threshold can be adjusted quickly.

As for the dynamic adjustment of the threshold described above, a higher cost is required if the adjustment is fast. Therefore, the threshold adjustment module is also configured to implement dynamic threshold selection.

As shown in FIG. 1, twelve different thresholds are set in the detection channel of the ranging device.

In one collection, if the noise is less than VF01, collected information by threshold VF01 can be considered as valid. While in one collection, if the noise is greater than VF01 but less than VF02, sampling data corresponding to the threshold VF01 can be considered as invalid, while sampling data corresponding to threshold VF02 is valid, and, for the time being, it can be considered that VF02 is the lowest of all thresholds.

Method of the dynamic threshold selection does not require fast switching of threshold voltage. It only needs to select the comparison threshold to be used (“select” appropriate collected data) from the set comparison thresholds in the collected data as final collection data according to the threshold-influencing factors and actual situation, which can not only reduce the cost but also increase computation speed.

It should be noted that, in order to better understand the two adjustment methods of the threshold adjustment module, some of the threshold-influencing factors are mentioned in the above explanation and description, but the threshold-influencing factors are not limited to the above examples. The adjustment methods of the threshold adjustment module with different threshold-influencing factors will be descried in detail below. With each threshold-influencing factor, the threshold can be adjusted through the above two methods, i.e., dynamic adjustment of the threshold and/or dynamic selection of threshold.

In the embodiments of the present disclosure, the ranging device will have different comparison thresholds to be used for different threshold-influencing factors. In order to realize the dynamic adjustment of the threshold and/or the dynamic selection of the threshold described above, data of functional relationship between the threshold-influencing factor and the comparison threshold to be used is pre-stored in the ranging device, so as to determine the comparison threshold to be used according to the functional relationship between the threshold-influencing factor and the comparison threshold to be used after the threshold-influencing factor is determined. Or a one-to-one correspondence numerical lookup table between the threshold-influencing factor and the comparison threshold to be used is pre-stored in the ranging device, and the corresponding comparison threshold to be used is searched in the lookup table after the threshold-influencing factor is determined.

In the present disclosure, the threshold-influencing factor includes at least one of the following: difference in detection direction of the ranging device, difference in the light noise, difference in the electronic noise, difference in receiving field of view, and temperature difference of a sensor configured to convert the light pulse signal into the electrical signal.

The threshold determination circuit is configured to determine the comparison threshold to be used according to at least one of the following threshold-influencing factors. I: Determining the comparison threshold to be used at each position according to difference in position where light signal is collected by the ranging device. II: Determining the comparison threshold to be used based on current magnitude of ambient light noise according to difference in the ambient light noise within field of view of the ranging device. III: Determining the comparison threshold to be used based on current temperature of the ranging device according to difference in operation temperature of the ranging device.

Therefore, the threshold adjustment module in the embodiments of the present disclosure will be described in detail below in conjunction with the threshold-influencing factors.

I: Difference in position of receiving field for collecting the light signal.

Difference in the position of the receiving field for collecting the light signal in the ranging device will cause difference in effective receiving area of the receiving field, and the different effective receiving areas correspond to different comparison thresholds to be used. Therefore, the position of each receiving field in the ranging device corresponds to a different comparison threshold to be used, and the threshold determination circuit is configured to determine the comparison threshold to be used according to actual receiving field position.

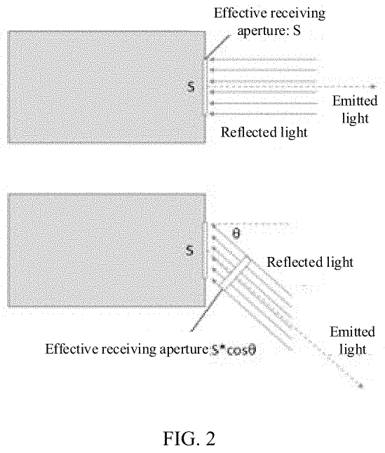

Specifically, during collection process of the LIDAR, effective receiving aperture is different at different positions within field of view (FOV), as shown in FIG. 2.

1. When an angle between the receiving field of view and an optical axis is not zero, the effective receiving area can be cosine corrected. For example, the effective receiving area of the receiving field is calibrated through cosine correction according to the angle between the receiving field of the light signal and the optical axis of the light signal.

After the effective receiving area is calibrated, the threshold determination circuit is configured to obtain the comparison threshold to be used in the effective receiving area according to the effective receiving area, so as to make dynamic adjustment.

2. When the angle between the receiving field and the optical axis changes, loss of receiving module itself is different, and the loss may be caused by loss of an optical device, occlusion in a structure, etc.

Therefore, distribution of noise amplitude within the FOV can be obtained according to actual measurement results or results such as theoretical calculations/simulations. When the LIDAR is operating, the threshold determination circuit is configured to set the corresponding comparison threshold to be used according to measured FOV position. Compared with fixed threshold scheme, the range can be increased on the premise of meeting false alarm noise index requirement, and range difference at different positions within the FOV can be reduced.

In the embodiments of the present disclosure, the threshold determination circuit dynamically adjusts/selects the threshold according to scanned FOV position/receiving aperture, which is conducive to reduce the range difference caused thereof: at a position where the receiving aperture is reduced, received echo power is less, received ambient light is less, and the light noise is also less, so the threshold can be lowered to compensate for some ranges.

II: Difference in the ambient light noise within the field of view of the ranging device.

In different scenarios, such as summer noon and dark night without light, the noise level is different. The difference in the noise level of ambient light within the field of view corresponds to different comparison threshold to be used, or the difference in the noise level of the ambient light at different angles and/or positions within the field of view of the ranging device corresponds to different comparison threshold to be used. Therefore, adjustment and/or selection can be made through the following methods.

1. Maximum noise level measured within the field of view is used as a reference for setting the current comparison threshold to be used. For example, the threshold determination circuit is configured to select the comparison threshold to be used corresponding to the maximum value of the noise level of the ambient light within the field of view of the ranging device, and compare the electrical signal with the comparison threshold to be used.

After the current comparison threshold to be used is determined according to the maximum noise level, the threshold determination circuit is configured to adjust the set comparison threshold to the current comparison threshold to be used, or the threshold determination circuit may also be configured to select at least part of the time information for calculation according to the current comparison threshold to be used.

The method is simple and easy to implement. However, if the different angles within the field of view are not distinguished, when the light is weak and the light noise is low at some angles, a farther distance can be measured in fact.

2. Dynamically adjusting and selecting an appropriate threshold for sampling according to light noise level at different angles within the field of view.

The difference in the noise level of the ambient light at different angles and/or positions within the field of view of the ranging device corresponds to different comparison thresholds to be used.

For example, the threshold selection at each angle in a next frame can be determined based on distribution of the light noise level in a previous frame. But if a measured environment is changing fast, then at a moment of fast changing, the threshold selection based on data of the previous frame will be wrong.

The noise level at the measurement angle can also be accurately obtained before each collection point. For example, a correspondence relationship between the noise level of the ambient light at different angles and/or positions within the field of view of the ranging device and the comparison threshold to be used is pre-stored in the ranging device, and the threshold determination circuit is configured to determine the comparison threshold to be used at different angles and/or positions according to the correspondence relationship, and compare the electrical signal with the selected comparison threshold to be used.

Before each point is collected, the noise level at the angle is obtained first, and then the comparison threshold to be used is adjusted, or a reasonable selection strategy for the comparison threshold to be used is developed accordingly. At least part of the time information is selected for calculation according to the current comparison threshold to be used.

According to the above improvements, even if amplitude of the light noise in the LIDAR changes correspondingly when the LIDAR is operating, the dynamic adjustment or dynamic selection of the comparison threshold described above is conducive to increase the system range. When the ambient light becomes weak (from day to night, from outside to tunnel or indoor, etc.), the noise amplitude decreases. In this case, the threshold is lowered accordingly to increase the range.

III: Difference in the operation temperature of the ranging device.

In the embodiments of the present disclosure, temperature also affects the noise level. Temperature has an impact on sensors, analog circuits, etc., whose noise level and noise gain have a certain correlation with the temperature. Different current temperatures in the ranging device correspond to different comparison thresholds to be used.

During calibration and compensation, it is needed to first measure change law of the noise at different temperatures and determine relationship data or formula between the temperature and the noise according to the law. The threshold determination circuit is configured to determine current noise level using the curve in the system, so as to determine threshold adjustment and selection strategy.

In addition to the difference in the threshold-influencing factors described above during the measurement process of the ranging device, since the ranging device may include multiple different detection channels, for example at least two detection channels, there are also differences in each detection channel, which include: electronic noise difference, light noise difference, detection direction difference, and position difference of the sensor for converting the light pulse signal into the electrical signal.

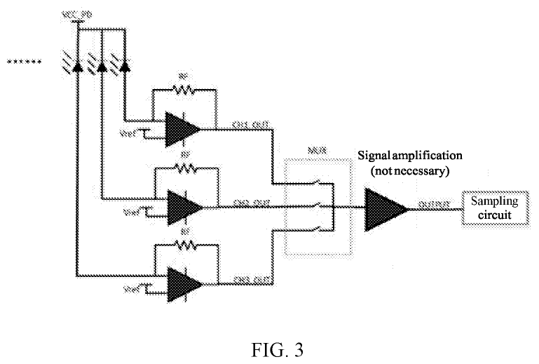

As shown in FIG. 3, among the different detection channels of the ranging device, even with the same ambient light intensity, due to the differences between different detection channels described above, the comparison threshold to be used in each detection channel is also different, and multiple different comparison thresholds to be used can be set in the multiple detection channels. Even in the same detection channel, at different moments, the corresponding comparison thresholds to be used are different at each time point. Therefore, multiple comparison thresholds to be used are correspondingly set in the same detection channel.

In some embodiments of the present disclosure, the ranging device also includes at least two transmission channels that correspond to the at least two detection channels one-to-one, and each of the detection channels is configured to receive the electrical signal reflected by the object from the light pulse emitted by the corresponding transmission channel. The threshold determination circuit is configured to determine the comparison threshold to be used according to the difference in different detection channels in the at least two detection channels, so as to keep the range of each detection channel consistent or close.

When the multiple detection channels share the same acquisition circuit, it is also needed to dynamically adjust and select the appropriate threshold according to the channel difference.

For example, there are differences in channels in the electronic noise. There are also channel differences in the light noise, and light gain of different detection channels may be different, so the light noise level is also different.

In addition, there are individual channel differences, that is, different positions of multiple sensors in an optical system. For example, light received by the sensor close to the optical axis is stronger, while light measured by the sensor far away from the optical axis is weaker, which is also a manifestation of the detection channel differences in the light noise. This type of light noise difference can be obtained from the theoretical calculations.

In order to eliminate the differences described above and adjust the comparison threshold, a correspondence relationship between the multiple detection channels and at least one of the electronic noise difference, the light noise difference, the detection direction difference, and the position difference of the sensor for converting the light pulse signal into the electrical signal may be pre-stored in the ranging device. For example, other channel differences that are inconvenient to calculate and obtain can be calibrated at factory to obtain information of the various detection channels, and stored in MCU or a FPGA-related storage device in the system.

Before the sampling circuit is switched to the corresponding detection channel, the comparison threshold is adjusted to an appropriate value.

After the comparison threshold to be used is obtained, the threshold determination circuit is configured to obtain the comparison threshold to be used for the operating detection channel according to the correspondence relationship, so as to compare the electrical signal with the comparison threshold to be used to obtain the time information of the electrical signal triggering the comparison threshold to be used. Or, after obtaining the time information of the electrical signal triggering a preset comparison threshold in the detection channel, the threshold determination circuit is configured to obtain the comparison threshold to be used for the detection channel according to the correspondence relationship, and select at least part of the time information for calculation based on the comparison threshold to be used.

When multiple transmission/reception lines are used in the LIDAR, due to optical design, hardware differences, etc. among different channels, there will be differences in signal echoes received by different lines when other conditions are the same. Through the comparison threshold adjustment and/or selection described above, it is conducive to reduce the range difference among the different lines.

When multiple transmission/reception lines are used in the LIDAR, noise of different lines is different due to hardware differences, etc. Through the comparison threshold adjustment and/or selection described above, the range of each line can be maximized, and different thresholds need to be used for each line.

In some other embodiments of the present disclosure, the ranging device includes: a light transmission circuit configured to emit a laser pulse signal; a laser reception circuit configured to receive at least part of a laser signal reflected by the object from the laser pulse signal emitted by the light transmission circuit, and convert the received laser signal into the electrical signal; a sampling circuit configured to sample the electrical signal from the laser reception circuit to obtain a sampling result; a computation circuit configured to calculate the distance between the object and the ranging device according to the sampling result.

In some embodiments, the transmission channel includes the light transmission circuit, and the detection channel at least includes the laser reception circuit, the sampling circuit, and the computation circuit. For functions and other settings of the transmission channel and the detection channel, reference can be made to the embodiments described above. In some other embodiments, the ranging device also includes the threshold determination circuit in the embodiments described above.

In some embodiments, the ranging device is configured to sense external environment information, such as distance information, orientation information, reflection intensity information, speed information, etc. of an environmental target. In one implementation manner, the ranging device can detect distance of a detected object to the ranging device by measuring time of light propagation, that is, time-of-flight (TOF), between the ranging device and the detected object. The ranging device can also detect the distance from the detected object to the ranging device by other techniques, such as a ranging method based on phase shift measurement or a ranging method based on frequency shift measurement, which is not limited herein.

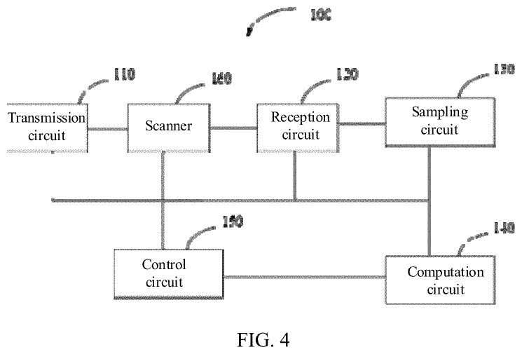

For better understanding, a ranging workflow will be described with examples in conjunction with a ranging device 100 shown in FIG. 4.

As shown in FIG. 4, the ranging device 100 includes a transmission circuit 110, a reception circuit 120, a sampling circuit 130, and a computation circuit 140.

The transmission circuit 110 can emit a light pulse sequence (e.g., a laser pulse sequence). The reception circuit 120 can receive the light pulse sequence reflected by a detected object and perform photoelectric conversion on the light pulse sequence to obtain an electrical signal, and then the electrical signal is processed and output to the sampling circuit 130. The sampling circuit 130 can sample the electrical signal to obtain a sampling result. The computation circuit 140 can determine distance between the ranging device 100 and the detected object based on the sampling result of the sampling circuit 130.

For example, the ranging device 100 also includes a control circuit 150, which can control other circuits, for example, can control operation time of each circuit and/or set parameters for each circuit.

It should be noted that although the ranging device shown in FIG. 4 includes a transmission circuit, a reception circuit, a sampling circuit, and a computation circuit, and is configured to emit a light beam for detection, the embodiments of the present disclosure are not limited thereto. Number of any one of the transmission circuit, the reception circuit, the sampling circuit, and the computation circuit may also be at least two, which are configured to emit at least two light beams in same direction or in different directions. The at least two light beams may be emitted simultaneous or may be emitted at different times. In some embodiments, light emitting chips in the at least two transmission circuits are packaged in same module. For example, each transmission circuit includes a laser emitting chip, and dies of the laser emitting chips in the at least two transmission circuits are packaged together and housed in same package space.

In some implementations, as shown in FIG. 4, the ranging device 100 also includes a scanner 160 for changing propagation direction of at least one light pulse sequence emitted by the transmission circuit.

A module including the transmission circuit 110, the reception circuit 120, the sampling circuit 130, and the computation circuit 140, or a module including the transmission circuit 110, the reception circuit 120, the sampling circuit 130, the computation circuit 140, and the control circuit 150 may be referred to as a ranging module, which can be independent of other modules, such as the scanner 160.

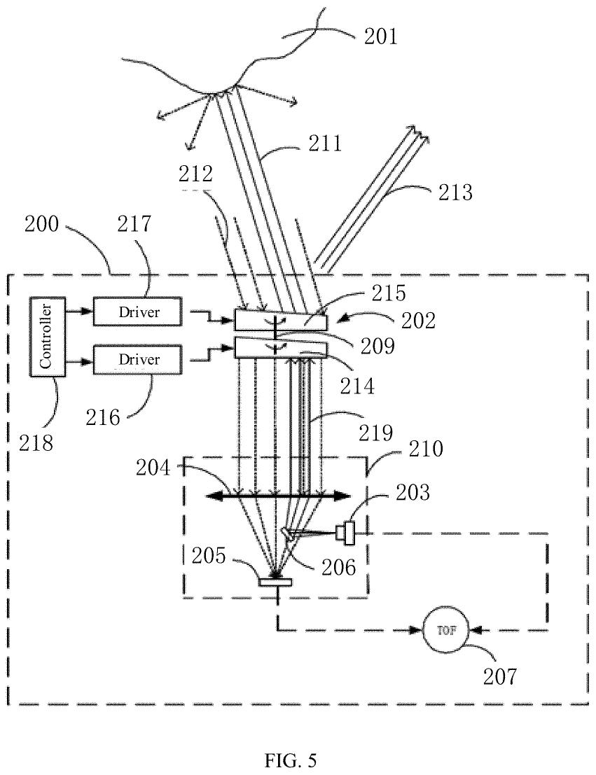

A coaxial light path can be used in the ranging device, that is, the light beam emitted by the ranging device and the reflected light beam share at least part of the light path within the ranging device. For example, after at least one laser pulse sequence emitted by the transmission circuit changes its propagation direction and emits through the scanner, the laser pulse sequence reflected by the detected object passes through the scanner and then enters the reception circuit. An off-axis light path can also be used in the ranging device, that is, the light beam emitted by the ranging device and the reflected light beam are respectively transmitted along different light paths within the ranging device. FIG. 5 shows a schematic diagram of a ranging device 200 using a coaxial light path according to an embodiment of the present disclosure.

The ranging device 200 includes a ranging module 210, which includes a transmitter 203 (which may include the transmission circuit described above), a collimation element 204, a detector 205 (which may include the reception circuit, the sampling circuit, and the computation circuit described above), and a light path changing element 206. The ranging module 210 is configured to emit the light beam, receive the reflected light, and convert the reflected light into the electrical signal. The transmitter 203 can be configured to emit the light sequence. In some embodiments, the transmitter 203 may emit the laser pulse sequence. For example, a laser beam emitted by the transmitter 203 is a narrow-bandwidth beam with a wavelength outside visible light range. The collimation element 204 is arranged on the transmission light path of the transmitter, and is configured to collimate the light beam emitted from the transmitter 203 and collimate the light beam emitted from the transmitter 203 into parallel light output to the scanner. The collimation element is also configured to converge at least part of the reflected light reflected by the detected object. The collimation element 204 may be a collimating lens or another element capable of collimating the light beam.

In the embodiments shown in FIG. 5, the transmission light path and the reception light path within the ranging device are merged before the collimation element 204 by the light path changing element 206, so that the transmission light path and the reception light path can share the same collimation element, which makes the light path more compact. In some other implementations, the transmitter 203 and the detector 205 may respectively use their own collimation elements, and the light path changing element 206 is arranged on the light path behind the collimation element.

In the embodiment shown in FIG. 5, since beam aperture of the light beam emitted by the transmitter 203 is small, and beam aperture of the reflected light received by the ranging device is large, the light path changing element can use a small-area reflector to merge the transmission light path and the reception light path. In some other implementations, the light path changing element may also use a reflector with a through hole, where the through hole is used to transmit emitted light of the transmitter 203 and the reflector is used to reflect the reflected light to the detector 205, which can reduce block of the reflected light from a support of a small reflector in case of using the small reflector.

In the embodiments shown in FIG. 5, the light path changing element is deviated from an optical axis of the collimation element 204. In some other implementations, the light path changing element may also be located on the optical axis of the collimation element 204.

The ranging device 200 also includes a scanner 202 arranged on the transmission light path of the ranging module 210. The scanner 202 is configured to change transmission direction of a collimated light beam 219 emitted by the collimation element 204 and project it to external environment. The reflected light is projected to the collimation element 204, and is converged on the detector 205 through the collimation element 204.

In some embodiments, the scanner 202 may include at least an optical element for changing propagation path of the light beam, and the optical element may change the propagation path of the light beam by reflecting, refracting, diffracting, etc. For example, the scanner 202 includes a lens, a reflector, a prism, a galvanometer, a grating, a liquid crystal, an optical phased array, or any combination of the above. In some embodiments, at least some of the optical elements are movable, for example, the at least some of the optical elements are driven to move by a drive module, and the movable optical element can reflect, refract or diffract the light beam to different directions at different times. In some embodiments, the multiple optical elements of the scanner 202 can rotate or vibrate around a common rotation axis 209, and each rotating or vibrating optical element is configured to continuously change the propagation direction of an incident light beam. In some embodiments, the multiple optical elements of the scanner 202 may rotate at different rotation speeds or vibrate at different speeds. In some other embodiments, the at least some of the optical elements of the scanner 202 may rotate at substantially the same rotation speed. In some embodiments, the multiple optical elements of the scanner may also rotate around different axes. In some embodiments, the multiple optical elements of the scanner may also rotate in the same direction or in different directions; or vibrate in the same direction or in different directions, which is not limited herein.

In some embodiments, the scanner 202 includes a first optical element 214 and a driver 216 connected to the first optical element 214. The driver 216 is configured to drive the first optical element 214 to rotate around the rotation axis 209, such that the first optical element 214 changes the direction of the collimated light beam 219, and the first optical element 214 projects the collimated light beam 219 to different directions. In some embodiments, angle between the direction of the collimated light beam 219 changed by the first optical element and the rotation axis 209 varies with the rotation of the first optical element 214. In some embodiments, the first optical element 214 includes a pair of opposing non-parallel surfaces through which the collimated light beam 219 passes. In some embodiments, the first optical element 214 includes a prism that varies in thickness along at least a radial direction. In some embodiments, the first optical element 214 includes a wedge angle prism that refracts the collimated light beam 219.

In some embodiments, the scanner 202 also includes a second optical element 215 that rotates around the rotation axis 209, and the rotation speed of the second optical element 215 is different from the rotation speed of the first optical element 214. The second optical element 215 is configured to change the direction of the light beam projected by the first optical element 214. In some embodiments, the second optical element 215 is connected to another driver 217 that drives the second optical element 215 to rotate. The first optical element 214 and the second optical element 215 can be driven by the same or different drivers, so that the rotation speed and/or rotation direction of the first optical element 214 and the second optical element 215 are different, thereby projecting the collimated light beam 219 to different directions in outside space, and a larger space can be scanned. In some embodiments, a controller 218 controls the drivers 216 and 217 to drive the first optical element 214 and the second optical element 215, respectively. The rotation speeds of the first optical element 214 and the second optical element 215 may be determined according to area and pattern expected to be scanned in actual applications. The drivers 216 and 217 may include motors or other drivers.

In some embodiments, the second optical element 215 includes a pair of opposing non-parallel surfaces through which the light beam passes. In some embodiments, the second optical element 215 includes a prism that varies in thickness along at least a radial direction. In some embodiments, the second optical element 215 includes a wedge angle prism.

In some embodiments, the scanner 202 also includes a third optical element (not shown) and a driver for driving the third optical element to move. For example, the third optical element includes a pair of opposing non-parallel surfaces through which the light beam passes. In some embodiments, the third optical element includes a prism that varies in thickness along at least a radial direction. In some embodiments, the third optical element includes a wedge angle prism. At least two of the first, second, and third optical elements rotate at different rotation speeds and/or rotation directions.

Each optical element in the scanner 202 can rotate to project light to different directions, such as directions of projected light 211 and projected light 213, so that a space around the ranging device 200 is scanned. When the projected light 211 projected by the scanner 202 hits a detected object 201, part of the light is reflected by the detected object 201 to the ranging device 200 in a direction opposite to the projected light 211. Reflected light 212 reflected by the detected object 201 is incident to the collimation element 204 after passing through the scanner 202.

The detector 205 and the transmitter 203 are arranged on the same side of the collimation element 204, and the detector 205 is configured to convert at least part of the reflected light passing through the collimation element 204 into an electrical signal.

In some embodiments, each optical element is plated with an anti-reflection coating. For example, thickness of the anti-reflection coating is equal to or close to wavelength of the light beam emitted by the transmitter 203, which can increase intensity of the transmitted light beam.

In some embodiments, a filter layer is plated on an element surface located on beam propagation path in the ranging device, or a filter is provided on the beam propagation path, which is configured to at least transmit wavelength band of the beam emitted by the transmitter and reflect other wavelength bands, so as to reduce noise caused by ambient light to receiver.

In some embodiments, the transmitter 203 may include a laser diode, and emit a nanosecond level laser pulse through the laser diode. Further, laser pulse receiving time can be determined, for example, by detecting rising edge time and/or falling edge time of an electrical signal pulse. As such, the ranging device 200 can calculate time of flight (TOF) using pulse receiving time information and pulse sending time information, so as to determine the distance between the detected object 201 and the ranging device 200.

The distance and orientation detected by the ranging device 200 can be used for remote sensing, obstacle avoidance, surveying and mapping, modeling, navigation, etc. In some embodiments, the ranging device according to the embodiments of the present disclosure can be applied to a mobile platform, and the ranging device can be mounted at a platform body of the mobile platform. The mobile platform with the ranging device can measure external environment, for example, to measure distance between the mobile platform and an obstacle for obstacle avoidance and other purposes, and to perform two-dimensional or three-dimensional surveying and mapping of the external environment. In some embodiments, the mobile platform includes at least one of an unmanned aerial vehicle, a car, a remote control vehicle, a robot, or a camera. When the ranging device is applied to an unmanned aerial vehicle, the platform body is a vehicle body of the unmanned aerial vehicle. When the ranging device is applied to a car, the platform body is a vehicle body of the car. The car can be a self-driving car or a semi-self-driving car, which is not limited here. When the ranging device is applied to a remote control vehicle, the platform body is a vehicle body of the remote control vehicle. When the ranging device is applied to a robot, the platform body is the robot. When the ranging device is applied to a camera, the platform body is the camera itself.

In addition, the present disclosure also provides a ranging method, which is based on the ranging device in the embodiments described above, so as to obtain the best signal-to-noise ratio in different scenarios, collect the weakest signal, and measure the farthest distance. The ranging method includes: determining the comparison threshold to be used according to the threshold-influencing factors; receiving the light pulse signal reflected by the object, converting the light pulse signal into the electrical signal, comparing the electrical signal with the comparison threshold to be used, obtaining the time information of the electrical signal triggering the comparison threshold to be used, and determining the distance between the object and the ranging device according to the time information.

For example, the method includes a process of adjusting the set comparison threshold according to the threshold-influencing factors. The method of adjusting the set comparison threshold includes dynamic threshold adjustment, that is, the threshold determination circuit is configured to adjust the set comparison threshold according to the threshold-influencing factors, and the comparison threshold to be used includes the adjusted comparison threshold.

Specifically, as shown in FIG. 1, in order to avoid the noise triggering the set comparison threshold, multiple different set comparison thresholds are usually set in the ranging device.

In some embodiments of the present disclosure, setting of the comparison threshold may be dynamically configured by a digital-to-analog conversion method (for example, using an analog-to-digital converter, digital-to-analog converter, DAC), a digital potentiometer, etc.

In the ranging device, the DAC is generally controlled by FPGA, MCU, or another central control unit. The central control unit dynamically sets the threshold according to stored individual difference and channel difference. The central control unit can also dynamically adjust the threshold according to some measured parameters such as external light intensity.

In some embodiments of the present disclosure, for example, in an environment with strong light noise, the central control unit learns this information and controls the DAC or another circuit part that can adjust the threshold to increase the threshold, so as to avoid high light noise. While in an environment with low light noise, such as an application scenario in dark night with no light, the threshold can be lowered to obtain a farther measurement distance.

The method also includes comparing the electrical signal with the set comparison threshold, and selecting the comparison threshold to be used from the set comparison thresholds according to the threshold influence: dynamic threshold selection. The detection channel is configured to compare the electrical signal with the set comparison threshold, and the threshold determination circuit is configured to select the set comparison threshold to be used from the set comparison thresholds according to the threshold-influencing factors. The detection channel is also configured to determine the distance between the object and the ranging device according to the time information corresponding to the comparison threshold to be used.

In actual applications, there are application scenarios that require fast switching. For example, in a multi-channel sensor scheme, if an acquisition circuit uses multiplexing mode, that is, the same threshold sampling circuit needs to time-division acquisition of different detection channels, and speed of switching between different channels is relatively fast, generally in us level. The individual differences between different channels (which will be described below) require that the threshold can be adjusted quickly.

As for the dynamic adjustment of the threshold described above, a higher cost is required if the adjustment is fast. Therefore, the threshold adjustment module is also configured to implement dynamic threshold selection.

As shown in FIG. 1, twelve different thresholds are set in the detection channel of the ranging device.

In one collection, if the noise is less than VF01, collected information by threshold VF01 can be considered as valid. While in one collection, if the noise is greater than VF01 but less than VF02, sampling data corresponding to the threshold VF01 can be considered as invalid, while sampling data corresponding to threshold VF02 is valid, and, for the time being, it can be considered that VF02 is the lowest of all thresholds.

Method of the dynamic threshold selection does not require fast switching of threshold voltage. It only needs to select the comparison threshold to be used (“select” appropriate collected data) from the set comparison thresholds in the collected data as final collection data according to the threshold-influencing factors and actual situation.

It should be noted that, in order to better understand the two adjustment methods of the threshold adjustment module, some of the threshold-influencing factors are mentioned in the above explanation and description, but the threshold-influencing factors are not limited to the above examples. The adjustment methods of the threshold adjustment module with different threshold-influencing factors will be descried in detail below. With each threshold-influencing factor, the threshold can be adjusted through the above two methods, i.e., dynamic adjustment of the threshold and/or dynamic selection of threshold.

In order to realize the dynamic adjustment of the threshold and/or the dynamic selection of the threshold described above, data of functional relationship between the threshold-influencing factor and the comparison threshold to be used is pre-stored in the ranging device, so as to determine the comparison threshold to be used according to the functional relationship between the threshold-influencing factor and the comparison threshold to be used after the threshold-influencing factor is determined. Or a one-to-one correspondence numerical lookup table between the threshold-influencing factor and the comparison threshold to be used is pre-stored in the ranging device, and the corresponding comparison threshold to be used is searched in the lookup table after the threshold-influencing factor is determined.

In the present disclosure, the threshold-influencing factor includes at least one of the following: difference in detection direction of the ranging device, difference in the light noise, difference in the electronic noise, difference in receiving field of view, and temperature difference of a sensor configured to convert the light pulse signal into the electrical signal.

The threshold determination circuit is configured to determine the comparison threshold to be used according to at least one of the following threshold-influencing factors. I: Determining the comparison threshold to be used at each position according to difference in position where light signal is collected by the ranging device. II: Determining the comparison threshold to be used based on current magnitude of ambient light noise according to difference in the ambient light noise within field of view of the ranging device. III: Determining the comparison threshold to be used based on current temperature of the ranging device according to difference in operation temperature of the ranging device.

For specific method for the threshold determination circuit to determine the comparison threshold to be used according to the threshold-influencing factors described above, reference can be made to the corresponding processes and methods in the embodiments of the ranging device described above, which will not be repeated herein. In some other embodiments, the corresponding processes and methods in the embodiments of the ranging device can be further improved or modified, as long as the above-mentioned objectives can be achieved.

The ranging method of the present disclosure is the same as the ranging device. By dynamically adjusting/selecting the threshold, the system range can be increased, and the range difference of different positions within the FOV can be reduced. Range difference among different lines of multi-line LIDAR can be reduced, and any line of the multi-line LIDAR can be optimized to increase the range.

The technical terms used in the embodiments of the present disclosure are only used to describe specific embodiments and are not intended to limit the present disclosure. As used herein, the singular forms “a,” “an,” and “the” are used to include the plural forms as well, unless the context clearly indicates otherwise. Further, the terms “include” and/or “including” used in the specification refer to the presence of the described features, integers, steps, operations, elements, and/or components, but do not exclude the presence or addition of one or more other features, integers, steps, operations, elements, and/or components.

The corresponding structures, materials, actions, and equivalents (if any) of all devices or steps and functional elements in the appended claims are intended to include any structure, material, or action for performing the function in combination with other explicitly claimed elements. The description of the present disclosure is presented for the purpose of examples and description, but is not intended to be exhaustive or to limit the present disclosure to the disclosed form. Various modifications and variations will be apparent to those skilled in the art without departing from the scope and spirit of the present disclosure. The embodiments described in the present disclosure can better disclose the principles and practical applications of the present disclosure, and enable those skilled in the art to understand the present disclosure.

The flow chart described in the present disclosure is only an embodiment, and various modifications and changes can be made to the chart or the steps in the present disclosure without departing from the spirit of the present disclosure. For example, these steps can be performed in a different order, or some steps can be added, deleted, or modified. Those skill in the art can understand that implementing of all or part of the processes of the embodiments described above and equivalent changes made in accordance with the claims of the present disclosure still fall within the scope of the present disclosure.

What is claimed is:

1. A ranging device comprising:
a threshold determination circuit configured to determine a candidate comparison threshold according to a threshold-influencing factor; and
a detection channel configured to receive a light pulse signal reflected by an object, convert the light pulse signal into an electrical signal, compare the electrical signal with the candidate comparison threshold, obtain time information of the electrical signal triggering the candidate comparison threshold, and determine a distance between the object and the ranging device according to the time information.

2. The ranging device of claim 1, wherein:
the threshold determination circuit is configured to adjust a set comparison threshold according to the threshold-influencing factor, the candidate comparison threshold including the adjusted comparison threshold; and/or
the detection channel is configured to compare the electrical signal with one or more set comparison thresholds, and the threshold determination circuit is configured to select the candidate comparison threshold from the one or more set comparison thresholds according to the threshold-influencing factor.

3. The ranging device of claim 1, wherein the threshold-influencing factor includes at least one of a difference in detection direction of the ranging device, a difference in light noise, a difference in electronic noise, a difference in receiving field of view, or a temperature difference of a sensor configured to convert the light pulse signal into the electrical signal.

4. The ranging device of claim 1, wherein the detection channel is one of at least two detection channels of the ranging device.

5. The ranging device of claim 4, further comprising:
at least two transmission channels having a one-to-one correspondence relationship with the at least two detection channels, each of the detection channels being configured to receive a light pulse emitted by a corresponding one of the at least two transmission channels and reflected by the object.

6. The ranging device of claim 4, wherein the threshold determination circuit is further configured to determine the candidate comparison threshold according to a difference between different detection channels of the at least two detection channels.

7. The ranging device of claim 6, wherein the difference between the different detection channels includes at least one of an electronic noise difference, a light noise difference, a detection direction difference, or a position difference of a sensor for converting the light pulse signal into the electrical signal.

8. The ranging device of claim 4, wherein minimum comparison thresholds used in at least some of the at least two detection channels within at least part of a time period are different.

9. The ranging device of claim 1, wherein the detection channel includes a comparator, a first input terminal of the comparator being configured to receive the electrical signal converted from the light pulse signal, a second input terminal of the comparator being configured to receive a set comparison threshold, and an output terminal of the comparator being configured to output comparison result including the time information corresponding to the electrical signal.

10. The ranging device of claim 9, wherein the detection channel further includes a time-to-digital converter electrically coupled to the output terminal of the comparator and configured to extract the time information corresponding to the electrical signal according to the comparison result output by the comparator.

11. The ranging device of claim 9, wherein:
the detection channel further includes a photoelectric conversion circuit configured to receive the light pulse signal, convert the light pulse signal into the electrical signal, and output the electrical signals; and
the comparator is configured to receive the electrical signal from the photoelectric conversion circuit.

12. The ranging device of claim 9, further comprising:
a controller connected to one terminal of the threshold determination circuit and configured to adjust the set comparison threshold to an adjusted comparison threshold.

13. The ranging device of claim 12, further comprising:
a digital-to-analog converter;
wherein the controller is connected to the second input terminal of the comparator through the digital-to-analog converter, and is configured to adjust the set comparison threshold by controlling a value of an output voltage of the digital-to-analog converter.

14. The ranging device of claim 1, wherein data of a functional relationship between the threshold-influencing factor and the candidate comparison threshold or a one-to-one correspondence numerical lookup table between the threshold-influencing factor and the candidate comparison threshold is pre-stored in the ranging device, and is used to obtain the candidate comparison threshold to be used after the threshold-influencing factor is determined.

15. The ranging device of claim 1, wherein the threshold-influencing factor includes at least one of a position where light signal is collected by the ranging device, an ambient light noise within a field of view of the ranging device, or an operation temperature of the ranging device.

16. The ranging device of claim 15, wherein an effective receiving area of a receiving field is different at different positions of the receiving field where the light signal is collected in the ranging device, different effective receiving areas corresponding to different candidate comparison thresholds.

17. The ranging device of claim 15, wherein:
the threshold determination circuit is configured to calibrate an effective receiving area of a receiving field according to an angle between the receiving field of the light signal and an optical axis of the light signal in the ranging device to obtain the candidate comparison threshold in the effective receiving area; or
a distribution of candidate comparison thresholds in the receiving field is pre-stored in the ranging device, the threshold determination circuit being configured to obtain the corresponding candidate comparison threshold according to a position of the receiving field.

18. The ranging device of claim 17, wherein the effective receiving area of the receiving field is calibrated through cosine correction according to the angle between the receiving field of the light signal and the optical axis of the light signal.

19. The ranging device of claim 1, wherein:
a correspondence relationship between each of a plurality of detection channels and at least one of an electronic noise difference, a light noise difference, a detection direction difference, or a position difference of a sensor for converting the light pulse signal into the electrical signal is pre-stored in the ranging device; and
the threshold determination circuit is further configured to:
obtain the candidate comparison threshold for an operating detection channel of the plurality of detection channels according to the correspondence relationship, to compare the electrical signal with the candidate comparison threshold to obtain the time information of the electrical signal triggering the candidate comparison threshold; or
after obtaining the time information of the electrical signal triggering a preset comparison threshold in the detection channel, obtain the candidate comparison threshold for the detection channel according to the correspondence relationship, and select at least part of the time information for calculation based on the candidate comparison threshold.

20. The ranging device of claim 1, wherein:
a difference in noise level of ambient light within a field of view of the ranging device corresponds to different candidate comparison thresholds; or
a difference in the noise level of the ambient light at different angles and/or positions within the field of view of the ranging device corresponds to different candidate comparison thresholds.

21. A ranging method comprising:
determining a candidate comparison threshold according to a threshold-influencing factor;
receiving a light pulse signal reflected by an object;
converting the light pulse signal into an electrical signal;
comparing the electrical signal with the candidate comparison threshold;
obtaining time information of the electrical signal triggering the candidate comparison threshold; and
determining a distance between the object and the ranging device according to the time information.
